(19) United States
(12) Patent Application Publication
(10) Pub. No.: US 2006/0059230 A1
(43) Pub. Date: Mar. 16, 2006

(54) System and method for transferring data between applications

(76) Inventors: John J. Dykas, Wethersfield, CT (US); Alan G. Kirk, Simsbury, CT (US); Thomas F. Wagner, Vernon, CT (US); Jeffrey L. Wayand, North Granby, CT (US)

Correspondence Address: DECHERT LLP, P.O. BOX 10004, PALO ALTO, CA, 94303-0961, US

(21) Appl. No.: 10/215,350

(22) Filed: Aug. 8, 2002

(51) Int. Cl. G06F 15/16

(52) U.S. Cl. 709/206; 709/207

(57) ABSTRACT

A method of transferring data between applications, wherein at least one datum relating to a subject is published by a first application over a transport infrastructure; and the published at least one datum is provided in accordance with a delivery protocol to a second application that has previously subscribed to the subject, subscription to a subject comprising specifying one of a plurality of delivery protocols; and the published at least one datum being provided in accordance with the delivery protocol specified in the course of the second application's subscription to the subject.

The present invention relates to transferring data between applications.

It is common in certain industries, such as the healthcare industry, for a company, or a company and its partners and customers, to need to transfer data between software applications not designed to work with each other. The difficulties in integrating the applications may have resulted from the merger of companies using different computer hardware and operating systems, and possibly located in disparate geographic locations, from a need to integrate applications not originally designed to work together, or from other causes. One option such companies can choose is to discontinue the use of the old applications in favor of a new set of applications designed to work together in a harmonious fashion. This option is, however, tremendously expensive and disruptive to business. New software must be purchased and installed, users must be trained in the use of the new software, and existing data must be transferred to the new applications. And once the new software has been exposed to real life demands in the organization or organizations, unforeseen shortcomings (in some cases catastrophic shortcomings) may be perceived in the new software by its users.

A system for transferring data between the several applications is therefore desirable to obviate the need for such expenses, disruptions, and risk.

### SUMMARY OF THE INVENTION

In one embodiment, the invention relates to a method of transferring data between applications, wherein at least one datum relating to a subject is published by a first application over a transport infrastructure; and the published at least one datum is provided in accordance with a delivery protocol to a second application that has previously subscribed to the subject, subscription to a subject comprising specifying one of a plurality of delivery protocols; and the published at least one datum being provided in accordance with the delivery protocol specified in the course of the second application's subscription to the subject.

In another embodiment, the invention relates to a system for transferring data between applications, including a first processor, a first memory in communication with the first processor, a second processor in communication with the first processor, a second memory in communication with the second processor, a first application stored in the first memory, and a second application stored in the second memory, wherein the first processor causes at least one datum relating to a subject from the first application to be published, wherein the second processor causes the published at least one datum to be provided in accordance with a delivery protocol to the second application, wherein the second application has previously subscribed to the subject, wherein subscription to a subject comprises specifying one of a plurality of delivery protocols, and wherein the published at least one datum is provided in accordance with the delivery protocol specified in the course of the second application's subscription to the subject.

In another embodiment, the invention relates to a system for transferring data between applications, including means for publishing at least one datum relating to a subject from a first application over a transport infrastructure and means for providing the published at least one datum in accordance with a delivery protocol to a second application that has previously subscribed to the subject, wherein subscription to a subject comprises specifying one of a plurality of delivery protocols and wherein the published at least one datum is provided in accordance with the delivery protocol specified in the course of the second application's subscription to the subject.

In another embodiment, the invention relates to a computer-readable medium having stored thereon computer-executable instructions for performing steps including publishing at least one datum relating to a subject from a first application over a transport infrastructure and providing the published at least one datum in accordance with a delivery protocol to a second application that has previously subscribed to the subject, wherein subscription to a subject comprises specifying one of a plurality of delivery protocols and wherein the published at least one datum is provided in accordance with the delivery protocol specified in the course of the second application's subscription to the subject.

In another embodiment, the invention relates to a method of transferring data between applications, including steps for publishing at least one datum relating to a subject from a first application and providing the published at least one datum in accordance with one of a plurality of delivery protocols to a second application.

In another embodiment, the invention relates to a computer-readable medium having stored thereon a data structure relating to the publication of at least one datum, including an attribute relating to a subject and an attribute relating to the at least one datum.

In another embodiment, the invention relates to a method of verifying the delivery of information to applications, including storing in a database information regarding the expected delivery of a message generated by a first application to a second application, verifying that the second application has received the message within an anticipated time frame, and sending a second message if the message has not been received by the second application within the anticipated time frame, wherein the first and second applications are run on different platforms.

In another embodiment, the invention relates to a method of verifying the delivery of information to applications, including steps for storing information regarding the expected delivery of a message generated by a first application to a second application, verifying that the second application has received the message within an anticipated time frame, and sending a second message if the message has not been received by the second application within the anticipated time frame, wherein the first and second applications are run on different platforms.

In another embodiment, the invention relates to a system for verifying the delivery of information to applications, including means for storing in a database information regarding the expected delivery of a message generated by a first application to a second application, means for verifying that the second application has received the message within an anticipated time frame, and means for sending a second message if the message has not been received by the second application within the anticipated time frame, wherein the first and second applications are run on different platforms.

In another embodiment, the invention relates to a computer-readable medium having stored thereon computer-executable instructions for performing steps including storing in a database information regarding the expected delivery of a message generated by a first application to a second application, verifying that the second application has received the message within an anticipated time frame, and sending a second message if the message has not been received by the second application within the anticipated time frame, wherein the first and second applications are run on different platforms.

In another embodiment, the invention relates to a system for verifying the delivery of information to applications, including a processor, a memory in communication with the processor, and a database stored in the memory, wherein the processor stores in the database information regarding the expected delivery of a message generated by a first application to a second application, wherein the processor verifies that the second application has received the message within an anticipated time frame, wherein the processor sends a second message if the message has not been received by the second application within the anticipated time frame, and wherein the first and second applications are run on different platforms.

In another embodiment, the invention relates to a computer-readable medium having stored thereon a data structure relating to the verification of delivery of information, including an attribute relating to a subject, an attribute relating to an expected time of delivery, and an attribute relating to a delay tolerance.

In another embodiment, the invention relates to a computer-readable medium having stored thereon a data structure relating to the verification of delivery of information, including an attribute relating to the identity of the sender of the at least one datum, an attribute relating to an expected time of delivery, and an attribute relating to a delay tolerance.

In another embodiment, the invention relates to a method of verifying the delivery of information to applications, including storing in a computer memory information regarding the expected delivery of a message generated by a first application to a second application, verifying that the second application has received the message within an anticipated time frame, and sending a second message if the message has not been received by the second application within the anticipated time frame, wherein the first and second applications are run on different platforms.

In another embodiment, the invention relates to a method of verifying the delivery of information to applications, including storing in a computer memory information regarding the expected delivery of a message generated by a first application to a second application, verifying that the second application has received the message within an anticipated time frame, and sending a second message if the message has not been received by the second application within the anticipated time frame, wherein the stored information includes information relating to the urgency of the message.

In another embodiment, the invention relates to a method of transferring medical insurance data between applications, including packaging at least one datum from a first application into a message in response to an event, sending the message across a transport infrastructure to a second application, unpackaging the at least one datum, and generating an event in the second application based at least in part on the at least one datum.

In another embodiment, the invention relates to a method of transferring employee benefit data between applications, including packaging at least one datum from a first application into a message in response to an event, sending the message across a transport infrastructure to a second application, unpackaging the at least one datum, and generating an event in the second application based at least in part on the at least one datum.

In another embodiment, the invention relates to a method of transferring employee benefit data between applications, including steps for packaging at least one datum from a first application into a message in response to an event, sending the message across a transport infrastructure to a second application, unpackaging the at least one datum, and generating an event in the second application based at least in part on the at least one datum.

In another embodiment, the invention relates to a computer-readable medium having stored thereon computer-executable instructions for performing steps including packaging at least one datum from a first application into a message in response to an event, sending the message across a transport infrastructure to a second application, unpackaging the at least one datum, and generating an event in the second application based at least in part on the at least one datum.

In another embodiment, the invention relates to a system for transferring employee benefit data between applications, including means for packaging at least one datum from a first application into a message in response to an event, means for sending the message across a transport infrastructure to a second application, means for unpackaging the at least one datum, and means for generating an event in the second application based at least in part on the at least one datum.

In another embodiment, the invention relates to a system for transferring employee benefit data between applications, including a first processor, a first memory in communication with the first processor, a second processor in communication with the first processor, a second memory in communication with the second processor, a first application stored in the first memory, and a second application stored in the second memory, wherein the first processor packages at least one datum from the first application into a message in response to an event, the first processor sends the message across a transport infrastructure to the second application, the second processor unpackages the at least one datum, and the second processor generates an event in the second application based at least in part on the at least one datum.

In another embodiment, the invention relates to a method of transferring employee benefit data between applications, including packaging at least a first set of data comprising at least one datum and a second set of data comprising at least one datum from a first application into a single message in response to an event, sending the message to a transport infrastructure, splitting the message into at least a first sub-message comprising at least the first set of data and a second sub-message comprising at least the second set of data, sending the first sub-message to a second application and sending the second sub-message to a third application, unpackaging the first sub-message and the second sub-message, and generating an event in the second application based at least in part on the first set of data and generating an event in the third application based at least in part on the second set of data.

In another embodiment, the invention relates to a method of transferring employee benefit data between applications, including packaging data from one or more applications including at least a first application into messages in response to events, sending the messages across a transport infrastructure to one or more applications including at least a second application, unpackaging the data, and generating events in at least the second application based at least in part on the data, wherein the priority with which the messages are delivered depends at least in part on priority rules associated with the first application.

In another embodiment, the invention relates to a method of transferring employee benefit data between applications, including pushing data generated by a first application across a transport infrastructure in near real time to generate an event in a second application, pushing data generated by a first application across a transport infrastructure in batch mode on a predetermined schedule to a second application, and pulling data generated by a first application across a transport infrastructure in real time in response to an event in a second application.

In another embodiment, the invention relates to a method of transferring employee benefit data between applications, including steps for pushing data generated by a first application in near real time to generate an event in a second application, pushing data generated by a first application in batch mode on a predetermined schedule to a second application, and pulling data generated by a first application in real time in response to an event in a second application.

In another embodiment, the invention relates to a computer-readable medium having stored thereon computer-executable instructions for performing steps including pushing data generated by a first application across a transport infrastructure in near real time to generate an event in a second application, pushing data generated by a first application across a transport infrastructure in batch mode on a predetermined schedule to a second application, and pulling data generated by a first application across a transport infrastructure in real time in response to an event in a second application.

In another embodiment, the invention relates to a system for transferring employee benefit data between applications, including means for pushing data generated by a first application across a transport infrastructure in near real time to generate an event in a second application, means for pushing data generated by a first application across a transport infrastructure in batch mode on a predetermined schedule to a second application, and means for pulling data generated by a first application across a transport infrastructure in real time in response to an event in a second application.

In another embodiment, the invention relates to a system for transferring employee benefit data between applications, including a processor, a first memory in communication with the processor, a second memory in communication with the processor, a first application stored in the first memory,; and a second application stored in the second memory, wherein the processor pushes data generated by the first application across a transport infrastructure in near real time to generate an event in the second application, the processor pushes data generated by the first application across a transport infrastructure in batch mode on a predetermined schedule to the second application, and the processor pulls data generated by the first application across a transport infrastructure in real time in response to an event in the second application.

### BRIEF DESCRIPTION OF THE DRAWINGS

FIG. 1 illustrates a system in accordance with an embodiment of the present invention.

FIG. 2 is a flowchart illustrating a first method in accordance with an embodiment of the present invention.

FIG. 3 is a flowchart illustrating a second method in accordance with an embodiment of the present invention.

FIG. 4 is a flowchart illustrating a third method in accordance with an embodiment of the present invention.

FIG. 5 is a flowchart illustrating a fourth method in accordance with an embodiment of the present invention.

FIG. 6 illustrates the schema of a database usable in accordance with an embodiment of the present invention.

### DETAILED DESCRIPTION OF THE INVENTION

The following terms shall have, for the purposes of this application, the respective meanings set forth below.

Adapter: A software application or portion thereof that packages and optionally formats data from a first application for delivery to a second application. In certain embodiments of the present invention, an adapter forms a part of each application.

Batch mode: With respect to the transmission of information, the periodic transmission of one or multiple items of information on a typically predetermined schedule.

Data; Information: Data and information shall have the same meaning for the purposes of the present application.

Delivery Protocol: The rules by which information is delivered to an application. A delivery protocol may specify one or more of whether information is to be delivered in batch, near real time, or real time mode, whether information is to be delivered so as to maintain synchronicity between multiple bodies of information, whether information is to be delivered in push or pull mode, the data format of the information, a delivery schedule, a delay tolerance, and other information.

Near Real Time: For the purposes of the present invention, information is transmitted in near real time if it is transmitted by a first application as a result of an event in such first application for delivery to a second application or human user with no more than a predetermined delay.

Platform: A combination of hardware and software characterizing a computer, such as an IBM compatible personal computer running a version of the Windows operating system or a risc workstation running a version of the Unix operating system.

Portal: A point of entry into a platform to which messages can be delivered and from which messages can be dispatched.

Publication: Transmission of data either directly to applications that have subscribed to data of that type or from that source, or to some intermediate location for ultimate distribution to such subscribers.

Real Time: For the purposes of the present invention, information is transmitted in real time if it is transmitted for immediate use by another application or a human user.

Subject: A category to which data can relate, such as all diagnosis data, diagnosis data relating to patients of a particular physician practice group or hospital or the identity of all patients currently insured by a company or division thereof

Subscription: Registration to receive data of a specified type or from a specified source or regarding a specified subject.

Transport Infrastructure: Hardware and software allowing computers to communicate with each other, especially computers from different platforms.

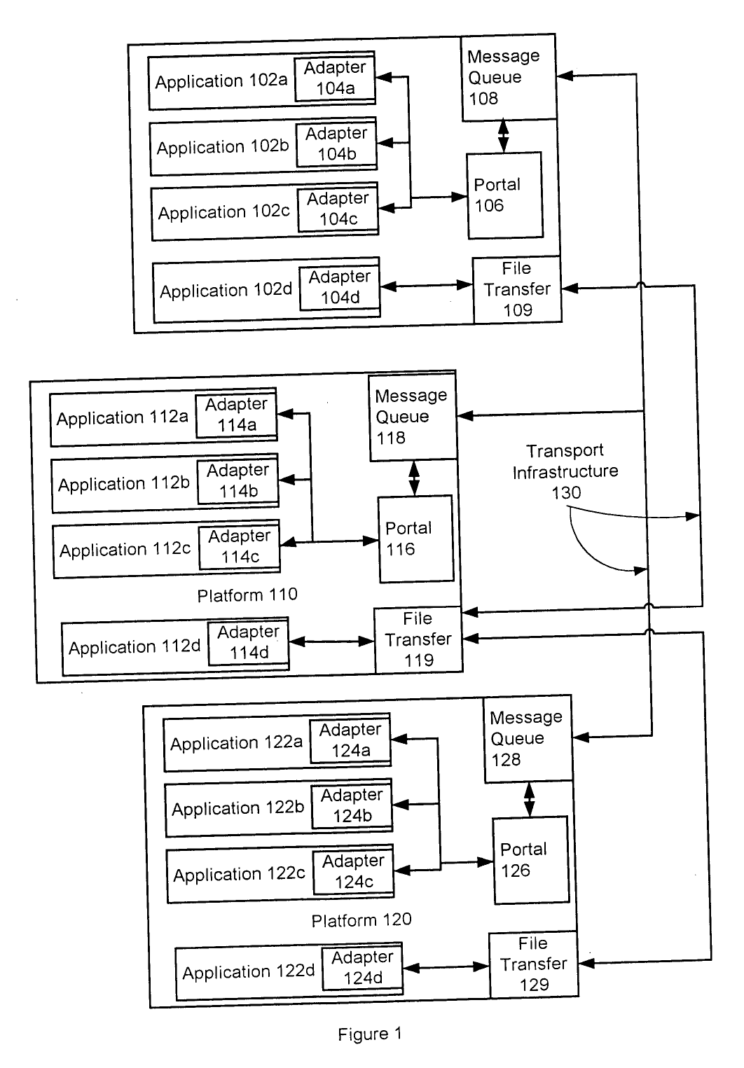

Referring to FIG. 1, an illustrative embodiment of a system in accordance with the present invention is illustrated. A plurality of platforms, platforms 100, 1 10, and 120, are connected together by transport infrastructure 130. The different platforms may be characterized by different hardware, such as mainframes, minicomputers, microcomputers (such as personal computers or risc workstations), or other computing devices, and different operating systems and other system level software (such as middleware). The different platforms may also be located in different geographic locations. A greater or lesser number of platforms may be present in any specific embodiment of the present invention.

Each platform includes one or more software applications, such as membership enrollment and eligibility, provider contracting, customer benefits, claims adjudication, customer inquiry, reporting, and banking and financial reporting, applications. In the exemplary embodiment, each platform includes a plurality of applications, such as applications 102a, 102b, and 102c. Each application in the exemplary embodiment includes an adapter, such as adapters 104a, 104b, and 104c, although in other embodiments, the adapters may be freestanding applications associated with specific business applications, or with groups of business applications. An adapter is responsible for formatting data and packaging and unpackaging messages containing such data. In some embodiments of the present invention, data is sent in its native format and adapters format such data for recipients only after receipt thereof by the recipients' adapters. In other embodiments, the senders' adapters format the data for its intended recipients. In still other embodiments, the senders' adapters format the data in a common format and the receivers' adapters reformat the data in the receivers' native formats. In yet other embodiments, some combination of the above methods is utilized.

Each application is connected to a portal, such as portal 106 through a message queue, such as message queue 108. The portal and the message queue can be part of the platform's operating system or middleware pertaining to that platform or can be part of transport infrastructure 130. The portal is an intermediary software layer between the application and the communication protocol software and specifically between the adapter and the communication protocol software in the exemplary embodiment. The portal's role relates to the setup and fulfillment of communication to a recipient computer. Services provided beyond communication can include one or more of encryption, data compression, transmission, authorization, and capturing tracking information, such as time sent/received and route traveled. In the exemplary embodiment the use of portals permits the adapters to package application data independently of the technology used to communicate the packaged data by the portals. In certain embodiments of the present invention, only one portal and one message queue may be present for each platform. In others, multiple portals, message queues, or both portals and message queues may be present for any or all of the platforms. For example, separate incoming and outgoing message queues may exist. Similarly, separate message queues may exist for use with different delivery protocols. Transportation infrastructure 130 can include networking hardware and software, such as a combination of IBM MQSeries, IBM MQSeries Integrator, IBM CICS-Client, native TCP/IP, SNA, XML, and SOAP in an exemplary embodiment, and computers, such as IBM mainframes, such IBM AS/400 and RS/6000 and other midrange platforms, Sun E10000, Microsoft NT servers and desktops, and Internet servers, containing subscription information, message delivery verification, and other databases and other software.

Optionally, separate facilities for transferring data in addition to the portals and message queues can exist. For example, in the exemplary embodiment, file transfer facilities 109, 119, and 129 permit applications, such as applications 102d, 112d, and 122d to transfer entire data files through a batch transfer process to other applications.

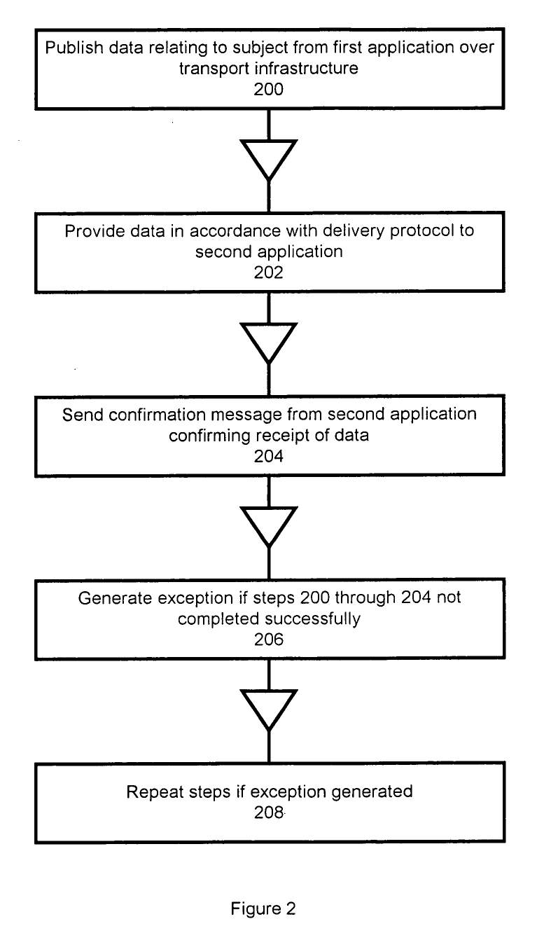

Referring to FIG. 2, a first method in accordance with the present invention is illustrated. In step 200, a first application published data relating to a subject over a transport infrastructure. In an exemplary embodiment, a message containing the published data is sent to a portal for each platform for subsequent delivery to each application on that platform that has previously subscribed to such information. In other embodiments, however, such data can be sent directly to subscribers.

In certain embodiments of the present invention, differing levels of urgency can be associated with data and such data can be published in step 200, and delivered in step 202, in an order based on such levels of urgency even if all such data is delivered by the same delivery protocol. Additionally, or alternatively, in certain embodiments, after the first application has published information as a single message, and before delivery thereto to the second application, such message can be split into multiple messages and the several submessages can be delivered separately to differing applications. A message can be so split into submessages based on information in the header, information in the data portion of the message, or a combination of both. For example, a header could contain a list of recipients together with a list of the segments of the message that each is to receive.

In step 202, the data is provided in accordance with a delivery protocol to a second application. In the exemplary embodiment, such data is provided to each subscriber to such data. The second invention can have previously subscribed to all information relating to one or more subjects. In the exemplary embodiment, the available delivery protocols include batch mode push, real time pull, and near real time push protocols and are selected prior to delivery of the data, such as during subscription to the subject. In other embodiments, the delivery protocol can be selected by the first application at the time of publication or by the second application at the time of receipt of the information or by other methods.

In step 204, in the exemplary embodiment, the second message sends a confirmation message confirming its receipt of the data. In addition, confirming messages can be sent at each stage of the process, for example messages confirming delivery to a queue on the first platform, messages confirming delivery to portals, etc. The message can be sent to the first application, to a central database for verifying delivery of messages, or elsewhere.

In step 206, an exception is generated in the exemplary embodiment if steps 200 through 204 are not performed correctly. The exception can be raised by the failure to receive a confirmation message in step 204, the delivery of invalid or corrupted information in step 202, the discovery of invalid or corrupt information subsequent to the performance of step 204, the failure of the first application to send the information in step 200, or otherwise. As those skilled in the art will appreciate, different types of exceptions can be raised to indicate the occurrence of different error conditions, and such different types of exceptions can be handled differently.

In step 208, if an exception is generated in step 206, at least one step is repeated. In some embodiments all of the steps are repeated. In other embodiments, the type of exception raised, or other information, indicates the steps not completed successfully and such steps are repeated.

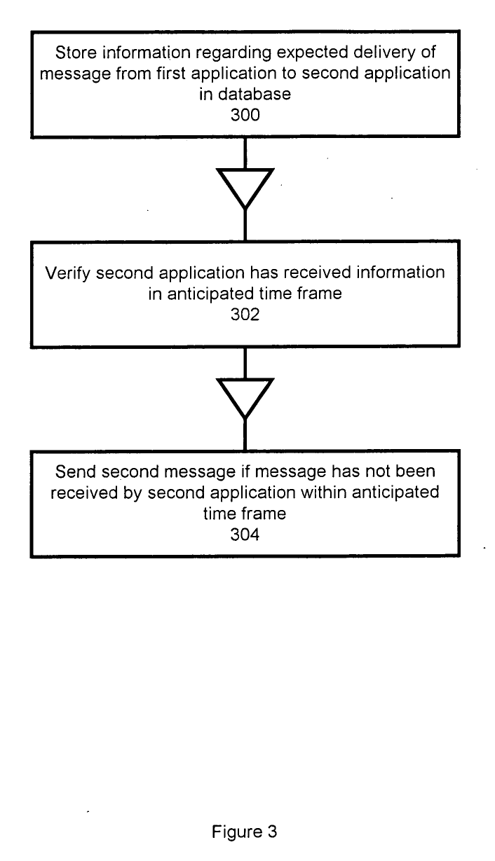

Referring to FIG. 3, a second method in accordance with the present invention is illustrated. In step 300, information regarding the expected delivery of a message from a first application to a second application, or from an application to a portal or message queue or other intermediary, or from a portal or message queue or other intermediary to an application, is stored in a database. Such delivery can utilize publish/subscribe or other methods for delivery. The information can include information identifying the sender or recipient of the information (or both, especially when publish/subscribe is not utilized), such as the name of the application or an internal identification number or code for such application, information identifying the message, such as an identification number or code, and information concerning the time of dispatch of the message or the estimated time of receipt thereof by the second application (or a portal or message queue or other intermediary). Optionally, other information, such as a tolerance for delay, the urgency of the underlying data, a delivery protocol to be utilized, and the specific action to be taken in step 304 if the message is not delivered successfully can also be stored at this or an earlier time. In different embodiments of the present invention step 300 and the other steps of the present method can be performed once for each message sent from a first application to a second application or repeatedly for multiple substeps relating to the process of sending a message from a first application to a second application. The database entries can be made upon the dispatch of a message or, if the messages are prescheduled messages, such as nightly batch updates, the entries can be made at earlier times instead (or in addition).

In step 302, it is verified that the second application (or portal or message queue or other intermediary) received the message. In certain embodiments of the present invention, receipt of a message by an application or portal, message queue, or other intermediary results in further entries being made in the database reflecting such successful delivery. A daemon or other application can then periodically consult the database and determine whether any messages that should have been delivered were not delivered.

In step 304, if it was determined in step 302 that a message was not delivered, a second message is sent, The second message can be a repeat of the first message or a notification of the failure to an application or a human (by e-mail, page, facsimile, automated telephone call, or other means).

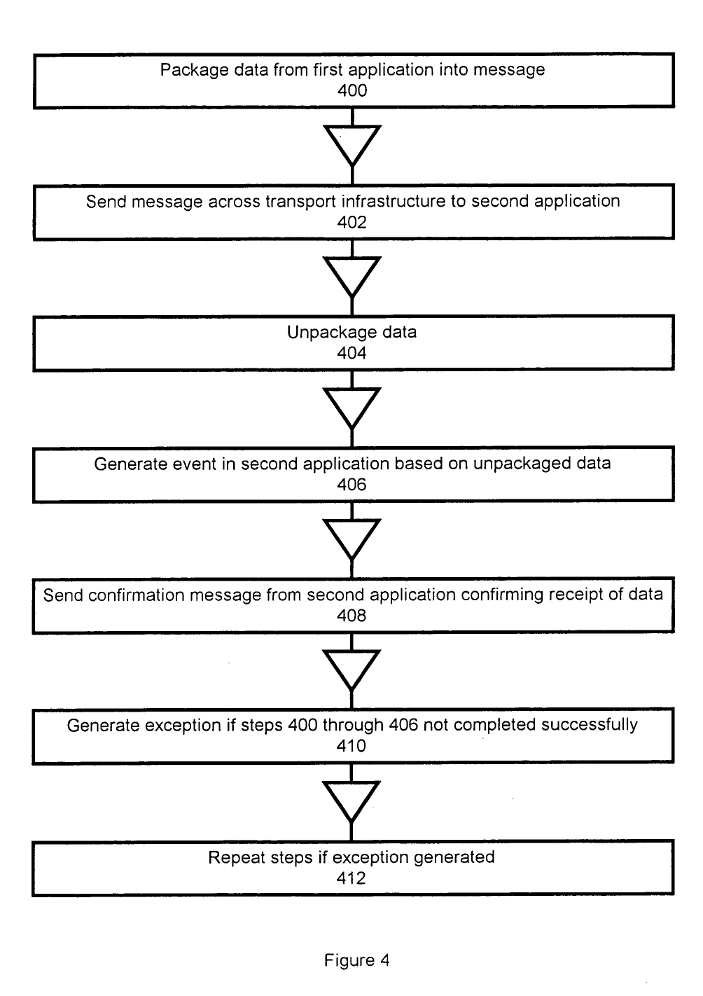

Referring to FIG. 4, a third method in accordance with the present invention is illustrated. In step 400, medical insurance data, employee benefit data, or other relating to the provision of medical services or goods to patients from a first application is packaged into a message. The first application can send the data to a separate or integrated adapter, which can add a message header and optionally reformat (and possibly also translate terminology or into other languages) the data into a common data format or into a data format used by the application or applications ultimately receiving the data. Formatting can include changes to data format, such as character format (e.g., ASCII, EBCDIC, or Unicode), numeric format (e.g., the number of bytes in a so-called floating point number) or the arrangement of the data (e.g., the ordering of fields within each record). Packaging can optionally include data compression (such as by omitting unused fields in records), data verification (e.g., verifying that the data is of the right type, such as verifying that a name field contains alphabetic characters and not numeric characters, or verifying that the data could be valid, such as verifying that the date of performance of medical services is a past date during the lifetime of the insured customer) and encryption in applications in which such functions are desirable.

In step 402, the packaged data is sent as a message across a transport infrastructure to a second application. Step 402 can be accomplished using publish/subscribe technology and portals and message queues, as described above, by sending messages directly to the intended recipients, or by other methods. Encryption, compression, formatting, translation, and authentication can be performed as a part of step 402, although all but the last can be performed instead in one or both of steps 400 and 404. In step 404, the data is unpackaged. In the exemplary embodiment, such unpackaging is performed by an adapter within the recipient application. The unpackaging can include stripping a message header, formatting or translating the data for use by the recipient application, data verification, and decompressing and decrypting data.

In step 406, an event is generated based on the unpackaged data. The event that is generated and the rules by which it is generated will vary depending on the recipient application. For example, an application for adding new customers to a list of insured customers might result in the addition of a new record containing the received data to a database of insured customers.

In step 408, in the exemplary embodiment, the second message sends a confirmation message confirming its receipt of the data. In addition, confirming messages can be sent at each stage of the process, for example messages confirming delivery to a queue on the first platform, messages confirming delivery to portals, etc. The message can be sent to the first application, to a central database for verifying delivery of messages, or elsewhere.

In step 410, an exception is generated in the exemplary embodiment if steps 400 through 406 are not performed correctly. The exception can be raised by the failure to receive a confirmation message in step 408, the delivery of invalid or corrupted information in step 402, the discovery of invalid or corrupt information during or subsequent to the performance of step 404, the failure of the first application to package the data in step 400 or to send the information in step 402, or otherwise. As those skilled in the art will appreciate, different types of exceptions can be raised to indicate the occurrence of different error conditions, and such different types of exceptions can be handled differently.

In step 412, if an exception is generated in step 410, at least one step is repeated. In some embodiments all of the steps are repeated. In other embodiments, the type of exception raised, or other information, indicates the steps not completed successfully and such steps are repeated.

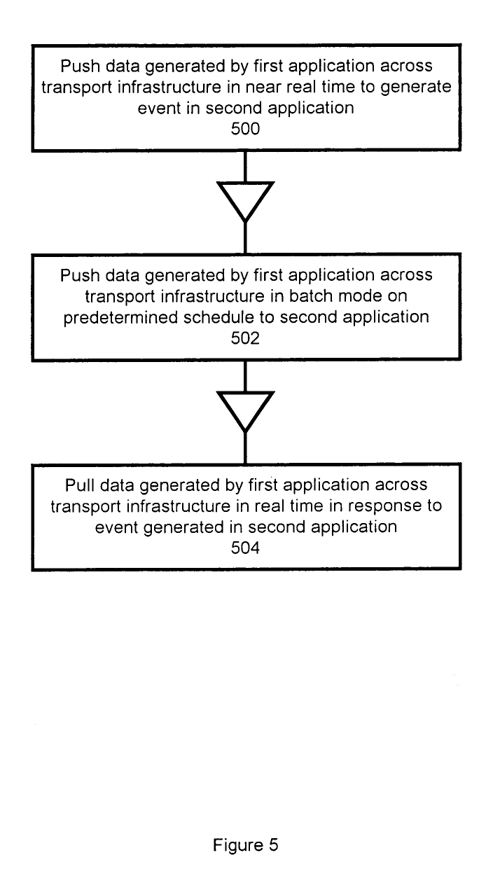

Referring to FIG. 5, a fourth method in accordance with the present invention is illustrated. In step 500, medical insurance data, employee benefit data, or other relating to the provision of medical services or goods to patients generated by a first application is pushed across a transport infrastructure in near real time to generate an event in a second application. In the exemplary embodiment, data that is pushed across the transport infrastructure in near real time includes data relating to physician referrals and authorizations of medical procedures and other data needed by patients, physicians, employers, or insurers on a substantially contemporaneous basis. Step 500 can be accomplished using the method illustrated in FIG. 4 or by using other methods.

In step 502, medical insurance data, employee benefit data, or other relating to the provision of medical services or goods to patients generated by a first application is pushed across a transport infrastructure in batch mode on a predetermined schedule to a second application. In the exemplary embodiment, data that is pushed across the transport infrastructure in batch mode includes annual enrollment data and other data that is both voluminous and not needed by the recipient application before a specific date (known at the time of transfer). Step 502 can be accomplished using the method illustrated in FIG. 2, with the delivery protocol being used being a batch mode push protocol.

In step 504, medical insurance data, employee benefit data, or other relating to the provision of medical services or goods to patients generated by a first application is pulled across a transport infrastructure in real time by a second application. Step 504 can be accomplished using the method illustrated in FIG. 2, with the delivery protocol being used being a real time pull protocol. An example of data that can be pulled in real time is data required to respond to a query sent by the second application to the first application, such as a request for a list of all formerly insured customers whose coverage has lapsed in the last month.

In certain embodiments of the present invention, the data format of messages can depend on the delivery protocol utilized. In an exemplary embodiment, the format for batch mode messages is completely variable. Each application receiving data in batch mode must be able to decode any message that might be sent to it from any application. Most permissible message parameters are based on the lowest common denominator of the applications sharing data. For example, the maximum size of a single data message is dependent upon the smallest maximum size of the applications sharing data.

In the exemplary embodiment, each real time or near real time message contains two portions, a header portion and a business data portion. The header portion provides information about where the data originates, what application is sending it, the destination of the data, what event triggered this transmission, what application needs to respond to this request, where it is located, time and date of publishing. The business data portion's format can vary; hence, the applications sharing data must use a commonly intelligible format. The size of the business data portion can be limited, such as to no more than 31,500 bytes. In the case of a near real time message, the header portion further contains a distribution list potentially listing multiple subscribers.

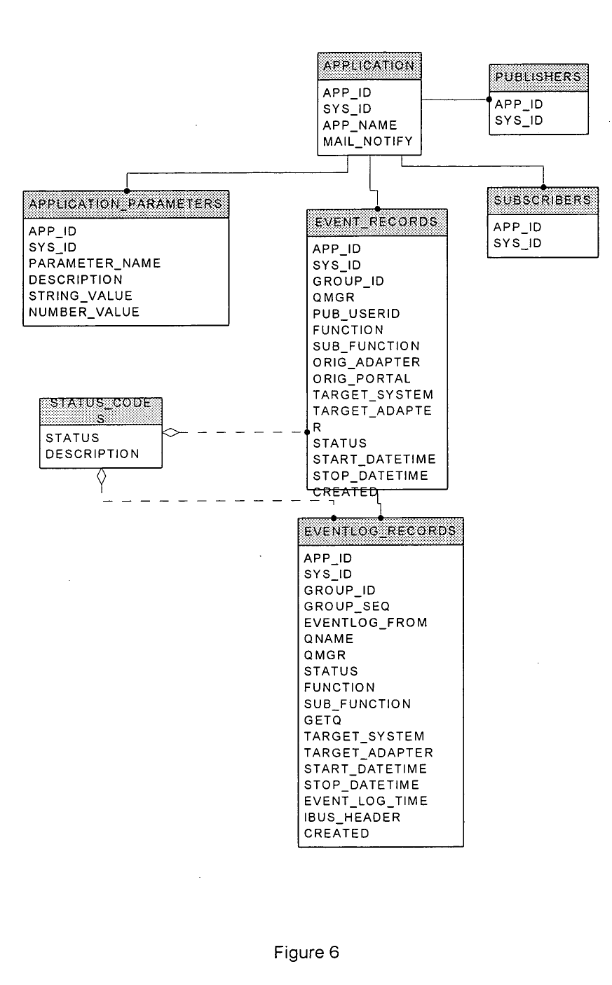

FIG. 6 illustrates the schema of a portion of a database used to store data relating to verifying the delivery of messages in an exemplary embodiment. With respect to each event that can trigger the transmission of messages using a publish/subscribe delivery protocol, the event_records table includes a record having fields for identifying uniquely an event, the identity of the publishing application, the identity of the publishing application's adapter and portal, the identity of the portal and adapter to which the message will be sent, other data, such as the scheduled beginning and ending date and time for message transmission, and parameters not shown in the figure, such as the urgency of a message and the permitted variance from its scheduled transmission time. Multiple records are necessary if the message will be sent to multiple adapters or portals. The eventlog_records table includes a corresponding record for each successful transmission of a message. By verifying that an eventlog record exists for each event that should occur, that is to say that an eventlog record exists for each event record, and that the eventlog record corresponds to the event record, program code can verify whether each scheduled message was sent and received successfully. Those skilled in the art will appreciate that many different database schemas can be utilized to provide this functionality and the above described schema is merely an example of a possible database schema.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

That which is claimed is:

1. A method of verifying the delivery of information to applications, comprising:
(a) storing in a database information regarding the expected delivery of a message generated by a first application to a second application;
(b) verifying that the second application has received the message within an anticipated time frame; and
(c) sending a second message if the message has not been received by the second application within the anticipated time frame,
wherein the first and second applications are run on different platforms.

2. The method of claim 1, wherein the second message is sent to the first application.

3. The method of claim 1, wherein the second message is sent to a third application.

4. The method of claim 1, wherein the second message is sent to at least one person.

5. The method of claim 4, wherein the second message is sent by electronic mail.

6. The method of claim 4, wherein the second message is sent by page.

7. The method of claim 1, wherein the message generated by the first application is generated on a batch schedule.

8. The method of claim 7, wherein step (a) comprises storing information related to the batch schedule in the database.

9. The method of claim 8, wherein the stored information comprises information relating to the size of the information sent.

10. The method of claim 8, wherein the stored information comprises information relating to the estimated size of the information sent.

11. The method of claim 8, wherein the stored information comprises information relating to the average size of a class of information sent by an application.

12. The method of claim 8, wherein the stored information comprises information relating to the estimated time of delivery of the information.

13. The method of claim 8, wherein the stored information comprises information relating to the estimated amount of time required for delivery of the information to the second application.

14. The method of claim 8, wherein the stored information comprises information relating to a delay tolerance relating to the delivery of the information.

15. The method of claim 8, wherein the stored information comprises information relating to the urgency of the information.

16. The method of claim 8, wherein the stored information comprises information relating to a type of second message to be sent.

17. The method of claim 8, wherein the stored information comprises information relating to the identity of the recipient of the second message.

18. The method of claim 8, wherein the stored information comprises information relating to the type of information being sent.

19. The method of claim 1, wherein the message generated by the first application is generated in near real time.

20. The method of claim 19, wherein the stored information comprises information relating to the estimated amount of time required for delivery of the information to the second application.

21. The method of claim 19, wherein the stored information comprises information relating to a delay tolerance relating to the delivery of the information.

22. The method of claim 19, wherein the stored information comprises information relating to the urgency of the information.

23. A method of verifying the delivery of information to applications, comprising steps for:
(a) storing information regarding the expected delivery of a message generated by a first application to a second application;
(b) verifying that the second application has received the message within an anticipated time frame; and
(c) sending a second message if the message has not been received by the second application within the anticipated time frame,
wherein the first and second applications are run on different platforms.

24. A system for verifying the delivery of information to applications, comprising:
means for storing in a database information regarding the expected delivery of a message generated by a first application to a second application;
means for verifying that the second application has received the message within an anticipated time frame; and
means for sending a second message if the message has not been received by the second application within the anticipated time frame,
wherein the first and second applications are run on different platforms.

25. A computer-readable medium having stored thereon computer-executable instructions for performing the steps comprising:
(a) storing in a database information regarding the expected delivery of a message generated by a first application to a second application;
(b) verifying that the second application has received the message within an anticipated time frame; and
(c) sending a second message if the message has not been received by the second application within the anticipated time frame,
wherein the first and second applications are run on different platforms.

26. A system for verifying the delivery of information to applications, comprising:
a processor;
a memory in communication with said processor; and
a database stored in said memory,
wherein said processor stores in said database information regarding the expected delivery of a message generated by a first application to a second application;
wherein said processor verifies that the second application has received the message within an anticipated time frame;
wherein said processor sends a second message if the message has not been received by the second application within the anticipated time frame; and
wherein the first and second applications are run on different platforms.

27. A computer-readable medium having stored thereon a data structure relating to the verification of delivery of information, comprising:
an attribute relating to a subject;
an attribute relating to an expected time of delivery; and
an attribute relating to a delay tolerance.

28. The computer-readable medium of claim 27, further comprising:
an attribute relating to an action to be taken if a message is not delivered within a delay tolerance of an expected time of delivery.

29. The computer readable medium of claim 27, wherein the data structure comprises an object.

30. The computer readable medium of claim 27, wherein the data structure comprises a database record.

31. The computer readable medium of claim 27, wherein the data structure comprises a record in a flat file.

32. A computer-readable medium having stored thereon a data structure relating to the verification of delivery of information, comprising:
an attribute relating to the identity of the sender of the at least one datum;
an attribute relating to an expected time of delivery; and
an attribute relating to a delay tolerance.

33. The computer-readable medium of claim 32, further comprising:
an attribute relating to an action to be taken if a message is not delivered within a delay tolerance of an expected time of delivery.

34. The computer readable medium of claim 32, wherein the data structure comprises an object.

35. The computer readable medium of claim 32, wherein the data structure comprises a database record.

36. The computer readable medium of claim 32, wherein the data structure comprises a record in a flat file.

37. A method of verifying the delivery of information to applications, comprising:
(a) storing in a computer memory information regarding the expected delivery of a message generated by a first application to a second application;
(b) verifying that the second application has received the message within an anticipated time frame; and
(c) sending a second message if the message has not been received by the second application within the anticipated time frame,
wherein the first and second applications are run on different platforms.

38. A method of verifying the delivery of information to applications, comprising:
(a) storing in a computer memory information regarding the expected delivery of a message generated by a first application to a second application;
(b) verifying that the second application has received the message within an anticipated time frame; and
(c) sending a second message if the message has not been received by the second application within the anticipated time frame,
wherein the information stored in step (a) comprises information relating to the urgency of the message.

39. A method of transferring medical insurance data between applications, comprising:
(a) in response to an event, packaging at least one datum from a first application into a message;
(b) sending the message across a transport infrastructure to a second application;
(c) unpackaging the at least one datum; and
(d) generating an event in the second application based at least in part on the at least one datum.

40. A method of transferring employee benefit data between applications, comprising:
(a) in response to an event, packaging at least one datum from a first application into a message;
(b) sending the message across a transport infrastructure to a second application;
(c) unpackaging the at least one datum; and
(d) generating an event in the second application based at least in part on the at least one datum.

41. The method of claim 40, wherein the first and second applications are incompatible.

42. The method of claim 40, wherein the first and second applications are stored on separate computers.

43. The method of claim 40, wherein the first and second applications are stored on separate computers located in different geographic locations.

44. The method of claim 40, wherein the first and second applications are stored on separate computers that run different operating systems.

45. The method of claim 40, wherein the first and second applications are stored on separate computers that run incompatible operating systems.

46. The method of claim 40, wherein the at least one datum packaged in step (a) is packaged by an adapter.

47. The method of claim 40, wherein the transport infrastructure comprises a plurality of portals.

48. The method of claim 47, wherein step (b) comprises sending the packaged message from the first application to a first portal, sending the packaged message from the first portal across the transport infrastructure to a second portal, and sending the packaged message from the second portal to the second application.

49. The method of claim 48, wherein at least one of the first and second portals comprises a message queue.

50. The method of claim 40, further comprising:
(e) dispatching a confirmation message from the second application confirming receipt of the message.

51. The method of claim 40, further comprising:
(e) generating an exception upon the failure successfully to complete any of steps (a) through (d).

52. The method of claim 51, further comprising:
(f) repeating the step with respect to which an exception was generated in step (e).

53. The method of claim 40, wherein step (b) comprises authenticating the identity of the first application.

54. The method of claim 40, wherein step (b) comprises authenticating the identity of the second application.

55. The method of claim 40, wherein step (a) comprises verifying the authority of the first application to publish data.

56. The method of claim 40, wherein step (a) comprises encrypting the at least one datum.

57. The method of claim 40, wherein step (a) comprises encrypting the message.

58. The method of claim 40, wherein step (b) comprises encrypting the message.

59. The method of claim 40, wherein step (a) comprises verifying the integrity of the at least one datum.

60. The method of claim 40, wherein step (b) comprises verifying the integrity of the at least one datum.

61. The method of claim 40, wherein step (c) comprises verifying the integrity of the at least one datum.

62. The method of claim 40, wherein step (d) comprises verifying the integrity of the at least one datum.

63. A method of transferring employee benefit data between applications, comprising steps for:
(a) in response to an event, packaging at least one datum from a first application into a message;
(b) sending the message across a transport infrastructure to a second application;
(c) unpackaging the at least one datum; and
(d) generating an event in the second application based at least in part on the at least one datum.

64. A computer-readable medium having stored thereon computer-executable instructions for performing the steps comprising:
(a) in response to an event, packaging at least one datum from a first application into a message;
(b) sending the message across a transport infrastructure to a second application;
(c) unpackaging the at least one datum; and
(d) generating an event in the second application based at least in part on the at least one datum.

65. A system for transferring employee benefit data between applications, comprising:
means for packaging at least one datum from a first application into a message in response to an event;
means for sending the message across a transport infrastructure to a second application;
means for unpackaging the at least one datum; and
means for generating an event in the second application based at least in part on the at least one datum.

66. A system for transferring employee benefit data between applications, comprising:
a first processor;
a first memory in communication with said first processor;
a second processor in communication with said first processor;
a second memory in communication with said second processor,
a first application stored in said first memory; and
a second application stored in said second memory,
wherein said first processor packages at least one datum from said first application into a message in response to an event;
wherein said first processor sends the message across a transport infrastructure to said second application;
wherein said second processor unpackages the at least one datum; and
wherein said second processor generates an event in said second application based at least in part on the at least one datum.

67. A method of transferring employee benefit data between applications, comprising:
(a) in response to an event, packaging at least a first set of data comprising at least one datum and a second set of data comprising at least one datum from a first application into a single message;
(b) sending the message to a transport infrastructure;
(c) splitting the message into at least a first sub-message comprising at least the first set of data and a second sub-message comprising at least the second set of data;
(d) sending the first sub-message to a second application and sending the second sub-message to a third application,
(e) unpackaging the first sub-message and the second sub-message; and
(f) generating an event in the second application based at least in part on the first set of data and generating an event in the third application based at least in part on the second set of data.

68. A method of transferring employee benefit data between applications, comprising:
(a) in response to events, packaging data from one or more applications including at least a first application into messages;
(b) sending the messages across a transport infrastructure to one or more applications including at least a second application;
(c) unpackaging the data; and
(d) generating events in at least the second application based at least in part on the data,
wherein the priority with which the messages are delivered in step (b) depends at least in part on priority rules associated with the first application.

69. The method of claim 68, wherein the priority with which the messages are delivered to the second application in step (b) depends in part on priority rules associated with the second application.

70. A method of transferring employee benefit data between applications, comprising:
(a) pushing data generated by a first application across a transport infrastructure in near real time to generate an event in a second application;
(b) pushing data generated by a first application across a transport infrastructure in batch mode on a predetermined schedule to a second application; and
(c) pulling data generated by a first application across a transport infrastructure in real time in response to an event in a second application.

71. The method of claim 70, wherein step (a) is performed asynchronously.

72. The method of claim 70, wherein step (b) is performed asynchronously.

73. The method of claim 70, wherein step (c) is performed synchronously.

74. A method of transferring employee benefit data between applications, comprising steps for:
(a) pushing data generated by a first application in near real time to generate an event in a second application;
(b) pushing data generated by a first application in batch mode on a predetermined schedule to a second application; and
(c) pulling data generated by a first application in real time in response to an event in a second application.

75. A computer-readable medium having stored thereon computer-executable instructions for performing the steps comprising:
(a) pushing data generated by a first application across a transport infrastructure in near real time to generate an event in a second application;
(b) pushing data generated by a first application across a transport infrastructure in batch mode on a predetermined schedule to a second application; and
(c) pulling data generated by a first application across a transport infrastructure in real time in response to an event in a second application.

76. A system for transferring employee benefit data between applications, comprising:
means for pushing data generated by a first application across a transport infrastructure in near real time to generate an event in a second application;
means for pushing data generated by a first application across a transport infrastructure in batch mode on a predetermined schedule to a second application; and
means for pulling data generated by a first application across a transport infrastructure in real time in response to an event in a second application.

77. A system for transferring employee benefit data between applications, comprising:
a processor;
a first memory in communication with said processor;
a second memory in communication with said processor;
a first application stored in said first memory; and
a second application stored in said second memory,
wherein said processor pushes data generated by said first application across a transport infrastructure in near real time to generate an event in said second application;
wherein said processor pushes data generated by said first application across a transport infrastructure in batch mode on a predetermined schedule to said second application; and
wherein said processor pulls data generated by said first application across a transport infrastructure in real time in response to an event in said second application.
